(19) United States
(12) Patent Application Publication
(10) Pub. No.: US 2007/0049317 A1
(43) Pub. Date: Mar. 1, 2007

(54) Controlling transmission power in a reverse link of a feedback-based spread spectrum wireless network

(76) Inventors: Bi Qi, Morris Plains, NJ (US); Yang Yang, Parsippany, NJ (US); Lily H. Zhu, Parsippany, NJ (US)

Correspondence Address: WILLIAMS, MORGAN & AMERSON, 10333 RICHMOND, SUITE 1100, HOUSTON, TX, 77042, US

(21) Appl. No.: 11/213,328

(22) Filed: Aug. 26, 2005

(51) Int. Cl. H04B 7/00; H04B 1/00

(52) U.S. Cl. 455/522; 455/69

(57) ABSTRACT

The present invention provides a method and an apparatus for communication with at least one wireless unit over a forward and a reverse link in a wireless network. The method includes receiving a feedback indication on at least a first channel over the forward link for reception of a transmission on at least a second channel over the reverse link, and adjusting transmit power of a wireless unit associated with the network based on the feedback indication. For example, a transmitter at a wireless unit associated with a spread spectrum wireless network, such as a code division multiple access cellular network, may control transmit power of in a reverse link. Specifically, the feedback indication for reception of a traffic or control channel over the reverse link may be received on a channel that is available on the forward link for another purpose than providing power control feedback. In this way, the transmitter performs reverse link power control at the wireless unit. By performing such reverse link power control, the transmitter obviates many conventional drawbacks associated with a receiver-centric power control in a feedback-based spread spectrum wireless communications system.

### FIELD OF THE INVENTION

This invention relates generally to telecommunications, and more particularly, to wireless communications.

### DESCRIPTION OF THE RELATED ART

Wireless communications systems or mobile telecommunication systems typically provide different types of services to different users or subscribers of wireless communication devices. The wireless communication devices may be mobile or fixed units and situated within a geographic region across one or more wireless networks. The users or subscribers of wireless units or communication devices, such as mobile stations (MSs) or access terminals or user equipment may constantly move within (and outside) particular wireless networks. A wireless unit may encompass additional features and applications than typically available on a conventional cellular phone. Examples of different features and applications include e-mail service, Internet access, audio-video interfaces for music and media content streaming.

A wireless communications system generally includes one or more base stations (BSs) that can establish wireless communications links with wireless units. Each wireless unit has an active set, which comprises a set of base stations with which it may communicate. Base stations may also be referred to as node-Bs or access networks. To form the wireless communications link between a wireless unit and a base station, the wireless unit accesses a list of available channels (or carriers) broadcast by the base station. To this end, a wireless communications system, such as a spread spectrum wireless communications system, may allow multiple users to transmit simultaneously within the same wideband radio channel, enabling a frequency re-use based on a spread spectrum technique.

In many cellular networks, higher data rates and stringent Quality of Service (QoS) requirements demand an improved management of radio frequency (RF) resources, such as control of transmission power in a wireless communication link. To accomplish transmission power control, transmit power is typically controlled in two ways. In a first implementation, a power control decision is determined by a receiver. In a second implementation, a power control decision is determined by a transmitter. Traditionally the first implementation has been used due to lack of feedback channels in a conventional wireless communications system.

However, feedback information may now be obtained in a high-speed wireless data network using a power control command channel. In high-speed wireless data networks, such as Evolved Data Optimized (EVDO), Evolution Data Voice (EVDV), traffic transmission uses different channel feedback techniques. For example, a reverse link traffic channel is used in an EVDO Rev. A network, which incorporates a hybrid automatic repeat request (HARQ) technique with use of a forward automatic repeat request (ARQ) channel to obtain the feedback. A reverse link Data Rate Control (DRC) channel in an EVDO network specifies use of a forward Data Rate Control Lock (DRCLock) channel as the feedback.

Many wireless data networks that operate in a code division multiple access (CDMA) mode generally employ power control to overcome a near-far problem. To this end, a close-loop power control is employed to adjust transmission power of a wireless unit. The power control is determined by a receiver for both an inner-loop and an outer-loop based on a desired packet reception performance and a packet error target. The power control commands are sent over a link other than the link used for packet transmission. Communication of the power control commands occupies radio frequency (RF) resource on that link.

Besides the RF resource usage, a receiver-centric power control in such feedback-based wireless data networks results in a variety of drawbacks, depending upon a particular situation. For instance, in a bursty traffic situation, since packet flows may no longer be continuous, performance of a power control implementation degrades. Likewise, in a multi-channel situation, consideration of multiple channel performance complicates a power control implementation. Complexity of a power control implementation increases when a feedback-based wireless data network having multi-flow traffic with different Quality of Service (QoS) requirements multiplexes the traffic on a common physical channel. In another situation, a poor power control command channel performance may result in a poor power control performance. For example, in the case of a link imbalance between a forward and a reverse link, such a poor power control performance may significantly degrade the traffic performance, causing a call to drop.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

The present invention is directed to overcoming, or at least reducing, the effects of, one or more of the problems set forth above.

In one embodiment of the present invention, a method is provided for controlling transmission power in a reverse link of a spread spectrum wireless network. The method includes receiving, on a first channel over a forward link, a feedback indication for reception of a relatively high-speed data transmission on a second channel over the reverse link, and adjusting transmit power of a wireless unit associated with the network based on the feedback indication.

In another embodiment of the present invention, a method is provided for enabling control of transmission power in a reverse link of a spread spectrum wireless network. The method comprises sending, on a non-feedback channel over a forward link, a feedback indication for reception of a relatively high-speed data transmission on a traffic channel over the reverse link, and causing a wireless unit associated with the network to adjust transmit power thereof based on the feedback indication.

In yet another embodiment of the present invention, a method is provided for enabling control of transmission power in a reverse link of a spread spectrum wireless network. The method comprises sending, on a non-feedback channel over a forward link, a feedback indication for reception of a relatively high-speed data transmission on a control channel over the reverse link, and causing a wireless unit associated with the network to adjust transmit power thereof based on the feedback indication.

### BRIEF DESCRIPTION OF THE DRAWINGS

The invention may be understood by reference to the following description taken in conjunction with the accompanying drawings, in which like reference numerals identify like elements, and in which:

FIG. 1 schematically depicts a spread spectrum wireless communications system, which includes first and second base stations that may control transmission power in a reverse link of a high-speed wireless data network based on feedback according to one illustrative embodiment of the present invention;

FIG. 2 schematically depicts the wireless unit to include the transmitter shown in FIG. 1 for providing the reverse link power control in accordance with one illustrative embodiment of the present invention;

FIG. 3 depicts a stylized representation for implementing a method of providing reverse link power control at the wireless unit in the spread spectrum wireless communication system, as shown in FIG. 1, consistent with an exemplary embodiment of the present invention;

FIG. 4 illustrates a stylized representation of one exemplary embodiment of the instant invention for implementing a method of using the transmitter rather than the receiver at the first base station to control transmit power in the reverse link; and

FIG. 5 illustrates a stylized representation of an exemplary embodiment of the instant invention for implementing a method of controlling transmit power in the reverse link that neither uses a power control command channel or an inner-loop and/or an outer-loop based power control modules at the receiver.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which will vary from one implementation to another. Moreover, it should be appreciated that such a development effort might be complex and time-consuming, but may nevertheless be a routine undertaking for those of ordinary skill in the art having the benefit of this disclosure.

Generally, a method and an apparatus are provided for controlling transmission power in a reverse link of a feedback-based spread spectrum wireless network. The method includes receiving, on a first channel over a forward link, a feedback indication for reception of a relatively high-speed data transmission on a second channel over the reverse link, and adjusting transmit power of a wireless unit associated with the network based on the feedback indication. For example, the feedback indication for reception of a traffic or control channel over the reverse link may be received on a channel that is available on the forward link for another purpose than providing power control feedback. In this way, power control in the reverse link may be performed at a transmitter associated with a wireless unit. By performing reverse link power control at the transmitter of the wireless unit, many conventional drawbacks associated with a receiver-centric power control in a feedback-based spread spectrum wireless network, such as a code division multiple access communications system may be obviated. For example, in an EVDO/EVDV or High-speed Downlink Packet Access (HSPDA) standard based access network, performance of a spread spectrum wireless communications system may be increased by reducing processing associated with reverse link power control for high-speed data. By avoiding use of a power control command overhead channel, efficiency of an air interface may be increased while enhancing transmitter characteristics. By moving the control of reverse link power control from a receiver to a transmitter, use of inner-loop and outer-loop power control modules at the receiver may be avoided in a high-speed wireless data network.

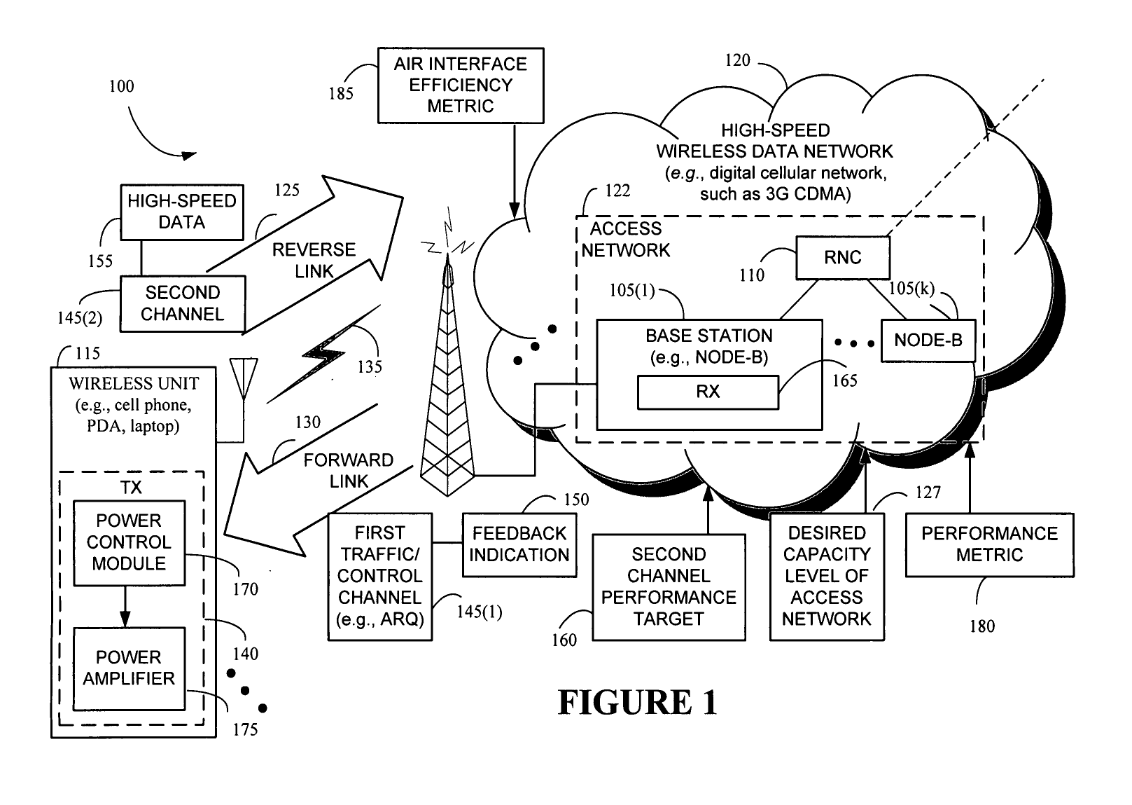

Referring to FIG. 1, a spread spectrum wireless communications system 100 is illustrated to include first and second base stations (BSs) 105(1-k) that may control transmission power in a reverse link 125 of a high-speed wireless data network 120 based on feedback according to one illustrative embodiment of the present invention. The first and second base stations 105(1-k) may provide the wireless connectivity to a wireless unit 115 according to any desirable protocol, including a Code Division Multiple Access (CDMA, cdma2000) protocol, an Evolved Data Optimized (EVDO, 1XEVDO) protocol, a Universal Mobile Telecommunication System (UMTS) protocol, a Global System for Mobile communications (GSM) protocol, and like.

Examples of the wireless unit 115 may include a host of wireless communication devices including, but not limited to, cellular telephones, personal digital assistants (PDAs), and global positioning systems (GPS) that employ the spread spectrum communications system 100 to operate in the high-speed wireless data network 120, such as a digital cellular CDMA network. Other examples of the wireless unit 115 may include smart phones, text messaging devices, and the like.

In the spread spectrum wireless communications system 100, the high-speed wireless data network 120 may deploy any desirable protocol to enable wireless communications between the first and second base stations 105(1-k) and the wireless unit 115 according to any desirable protocol. Examples of such a protocol include a (CDMA, cdma2000) protocol, an Evolved Data Optimized (EVDO, 1XEVDO) protocol, a UMTS protocol, a GSM protocol, and like.

A radio network controller (RNC) 110 may be coupled to the first and second base stations 105(1-k) to enable a mobile user of the wireless unit 115 to communicate over the relatively high-speed wireless data network 120, such as a cellular network. One example of the high-speed wireless data network 120 includes a digital cellular network based on a CDMA protocol, such as specified by the 3rd Generation (3G) Partnership Project (3GPP) specifications. The 3G cellular systems provide enhanced voice capacity and support high data rate packet based services. These features are provided in cdma2000 1xEV high rate packet data air system referred to as IS-856. The 3G cellular system CDMA2000 1xEV provides high-speed wireless Internet access to users with asymmetric data traffic relative to a cellular system based on IS-95 standard. For example, data rate of a user of the wireless unit 115 may very from 9.6 kbps to 153.6 kbps.

Other examples of such a protocol include a 1xEV-DO protocol, a UMTS protocol, a GSM protocol, and like. The radio network controller 110 may manage exchange of wireless communications between the wireless unit 115 and the first and second base stations 105(1-k) according to one illustrative embodiment of the present invention. Although two base stations 105(1-k) and one radio network controller 110 are shown in FIG. 1, persons of ordinary skill in the pertinent art having benefit of the present disclosure should appreciate that any desirable number of base stations 105 and radio network controllers 110 may be used.

Each of the first and second base stations 105(1-k), sometimes referred to as Node-Bs, may provide connectivity to associated geographical areas within the high-speed wireless data network 120. Although the high-speed wireless data network 120 is shown to include the first and second base stations 105(1-k) coupled to the radio network controller 110 in FIG. 1, persons of ordinary skill in the art should appreciate that portions of the high-speed wireless data network 120 may be suitably implemented in any number of ways to include other components using hardware, software, or a combination thereof. High-speed wireless data networks are known to persons of ordinary skill in the art and so, in the interest of clarity, only those aspects of the high-speed wireless data network 120 that are relevant to the present invention will be described herein.

Consistent with one embodiment, the wireless unit 115 may transmit messages to the first base station 105(1) or the second base station 105(k) over the reverse link 125. A single forward link 130 may provide messages to the wireless unit 115. The messages may include traffic packets and signaling messages. The cdma2000 1xEV-DO specification uses a frequency band with channel bandwidth (1.23 MHz) and chip rate (1.2288 Mcps). In cdma2000 1xEV-DO, for example, each forward link frame is 26.666 msec and consists of 16 slots. Like the forward link, the reverse link frame is 26.666 msec and consists of 16 slots.

In the spread spectrum wireless communications system 100, mobile communications that communicate the messages between the first and second base stations 105(1-k) and the wireless unit 115 may occur over an air interface 135 via a radio frequency (RF) medium that uses a code division multiple access (CDMA) protocol to support multiple users. When moving within the high-speed wireless data network 120, such as a digital cellular CDMA network, a handover of mobile communications occurs for the wireless unit 115 upon a user leaving an area of responsibility of a first cell, namely, into a new cell. This handover may be coordinated by the radio network controller 110.

According to one illustrative embodiment of the present invention, the wireless unit 115 may comprise a transmitter (TX) 140 that controls transmission power in the reverse link 125 from the wireless unit 115 to the first base station 105(1). The transmitter 140 may be suitably implemented in any number of ways using hardware, software, or a combination thereof to provide a reverse link power control at the wireless unit 115. Such reverse link power control at the wireless unit 115 may cause the transmitter 140 to increase capacity of an access network 122 by a desired level 127.

As used herein, the term “reverse link power control” refers to availability of one or more radio resources, such as radio frequency (RF) resources, that may be used to form the reverse link 125(1) from the wireless unit 115, as well as the various features that may be provided to the first base station 105(1). For example, the transmitter 140 may enable the wireless unit 115 to transmit at a relatively higher data rate.

By increasing capacity of the access network 122 in the spread spectrum wireless communications system 100, for example, in a cdma2000 1xEV-DO or 1xEV-DV protocol based system, increased data rates within a 1.25 MHz carrier may provide relatively high rate data packet services to meet user demands of a high-speed web or email access. The cdma2000 1xEV-DO specification uses the term “access network” for a base station, and “access terminal” for a wireless unit, however, in the illustrated embodiment, the access network 122 is shown to encompass the first and second base stations 105(1-k).

More specifically, the transmitter 140 may receive, on a first channel 145(1) over the forward link 130, a feedback indication 150 for reception of a relatively high-speed data 155 transmission on a second channel 145(2) over the reverse link 125. In response, the transmitter 140 may adjust transmit power of the wireless unit 115 associated with the network 120 based on the feedback indication 150.

Consistent with one embodiment, to adjust transmit power in the reverse link 125, the transmitter 140 may detect transmission activity on the first and second channels 145(1-2). That is, the wireless unit 115 may receive the feedback indication 150 for reception of a traffic or control channel on a channel that is available on the forward link 130 for another purpose than providing feedback. In one illustrative embodiment, the transmitter 140 may receive the feedback indication 150 on an acknowledgment (ACK) channel or an automatic repeat request (ARQ) channel available on the forward link 130, as two examples.

The transmitter 140 may comprise a module 170 capable of power control in the reverse link 125. The module 170 may be coupled to a power amplifier 175. Using the feedback indication 150, the module 170 may determine whether an adjustment to the transmit power is desirable at the wireless unit 115. If so, the module 170 may cause the power amplifier 175 to change the transmit power. In this manner, in response to either not detecting any transmission activity and/or determining that some adjustment is desired, the transmitter 140 may control the transmit power of the wireless unit 115 to obtain a performance target 160 for the second channel 145(2).

By controlling the transmit power of the wireless unit 115, in some embodiments, the transmitter 140 may provide reverse link power control. The ACK channel or the ARQ channel available on the forward link 130 between a base station controller at the first base station 105(1) and the wireless unit 115 may be used to receive an indication for reverse traffic or control channel performance from a receiver (RX) 165 associated with the base station controller. To perform power control in the reverse link 125, the transmitter 140 may control the transmit power of the wireless unit 115 in a way that causes the transmitter 140 to reach the performance target 160 for a reverse traffic or control channel.

In this way, the transmitter 140 may reduce latency and/or processing associated with performing the power control in the reverse link 125 for the transmission of relatively high-speed data 155. By reducing the latency and processing, the transmitter 140 may significantly enhance a performance metric 180 of the access network 122. Likewise, the transmitter 140 may substantially eliminate an overhead associated with a power control command channel. As a result of reduction in the overhead or elimination thereof, the transmitter 140 may enhance an efficiency metric 185 of the air interface 135 of the forward link 130 in the spread spectrum wireless communications system 100.

However, persons of ordinary skill in the art having benefit of the present disclosure should appreciate that the present invention is not limited to, the desired capacity level 127 of the access network 122, the performance metric 180 of the access network 122, and the efficiency metric 185 of the air interface 135 of the forward link 130. In alternative embodiments, the transmitter 140 may enable the wireless unit 115 to provide different capabilities and/or additional capabilities with the reverse link power control for high-speed data 155.

According to one embodiment, the wireless unit 115 may transmit messages or signals to one or more active base stations using one or more associated reverse links. Pseudo noise offsets (PN offsets) associated with each of the active base stations are included in an active set list, which is typically stored by the radio network controller 110 coupled to the first and second base stations 105(1-k). The wireless unit 115 may receive messages and/or signals over the forward link 130 between the wireless unit 115 and one of the active base stations, which is generally referred to as the serving base station or the serving sector. The 3rd Generation Partnership Project (3GPP) standard defines the role of a serving radio network controller based on 3GPP specifications.

Besides the messages or signals, the wireless unit 115 may receive traffic packets, such as data packets. Often the traffic packets include information that is intended for the user of the wireless unit 115. For example, traffic packets may include voice information, images, video, data requested from an Internet site, and the like. In contrast, signaling messages are used to provide information intended to be used by the wireless unit 115 and/or other elements of the spread spectrum wireless communications system 100. Specifically, signaling messages may include configuration messages, setup instructions, switch instructions, handoff instructions, and the like.

In one embodiment, the reverse link 125 and the forward link 130 may be established on a plurality of channels. The channels, such as traffic and control channels may be associated with separate channel frequencies. For example, CDMA channels with associated channel number and frequency may form a wireless communication link for transmission of the high-speed data 155. In the forward link 130, for example, the wireless unit 115 may update the first base station 105(1) with a data rate to receive transmissions on a Forward Traffic Channel or a Forward Control Channel. The Traffic Channel carries user data packets. The Control Channel carries control messages, and it may also carry user traffic. The forward link 130 may use a Forward MAC Channel that includes three sub-channels including a Reverse Power Control (RPC) Channel, a Data Rate Control Lock (DRCLock) Channel, and a Reverse Activity (RA) Channel.

In the reverse link 125, the wireless unit 115 may transmit on an Access Channel or a Traffic Channel. The Access Channel includes a Pilot Channel and a Data Channel. The Traffic Channel includes Pilot, MAC and Data Channels. The MAC Channel comprises three sub-channels including a Reverse Rate Indicator (RRI) sub-channel that is used to indicate whether the Data Channel is being transmitted on the Reverse Traffic Channel and the data rate. Another sub-channel is a Data Rate Control (DRC) that is used by the wireless unit 115 to indicate to the first base station 105(1) a data rate that the Forward Traffic Channel may support and the best serving sector. An acknowledgement (ACK) sub-channel is used by the wireless unit 115 to inform the first base station 105(1) whether the data packet transmitted on the Forward Traffic Channel has been received successfully.

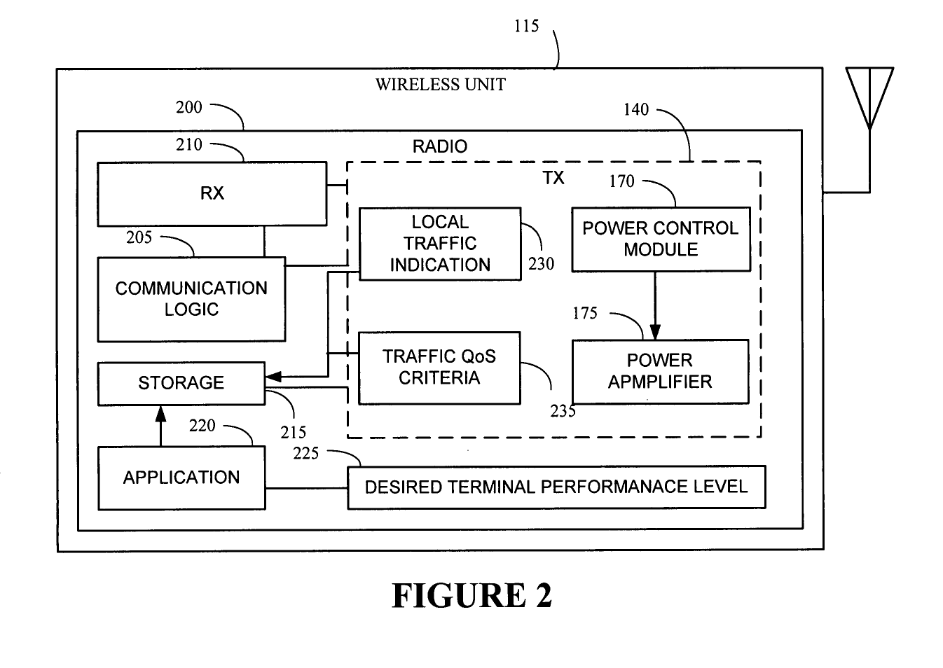

Referring to FIG. 2, the wireless unit 115 is depicted to include the transmitter 140 shown in FIG. 1 for providing the reverse link 125 power control in accordance with one illustrative embodiment of the present invention. The wireless unit 115 comprises a radio 200 that includes a communication logic 205 coupled to a receiver (RX) 210 and the transmitter (TX) 140 that enable the radio 200 to form wireless communication links including the reverse link 125 with the first base station 105(1) and the forward link 130 thereto.

The transmitter 140 may comprise the module 170 and the power amplifier 175 to adjust the transmit power of the wireless unit 115 based on the feedback indication 150. The radio 200 may further comprise a storage 215 coupled to the transmitter 140 to store an application 220 capable of executing at the wireless unit 115. Using the module 170 and the power amplifier 175, the wireless unit 115 may cause the transmitter 140 to execute the application 220 at a desired performance level 225.

The module 170 and the power amplifier 175 may adjust the transmit power of the transmitter 140 based on a local traffic indication 230 and/or a traffic quality of service (QoS) criteria 235. For example, the local traffic indication 230 may indicate, a burst traffic situation where packet flows are not continuous, to the module 170, which in turn, tunes the power amplifier 175. Such tuning of the power amplifier 175 may prevent the traffic performance to degrade so that the traffic QoS criteria 235 may be met, avoiding a call drop.

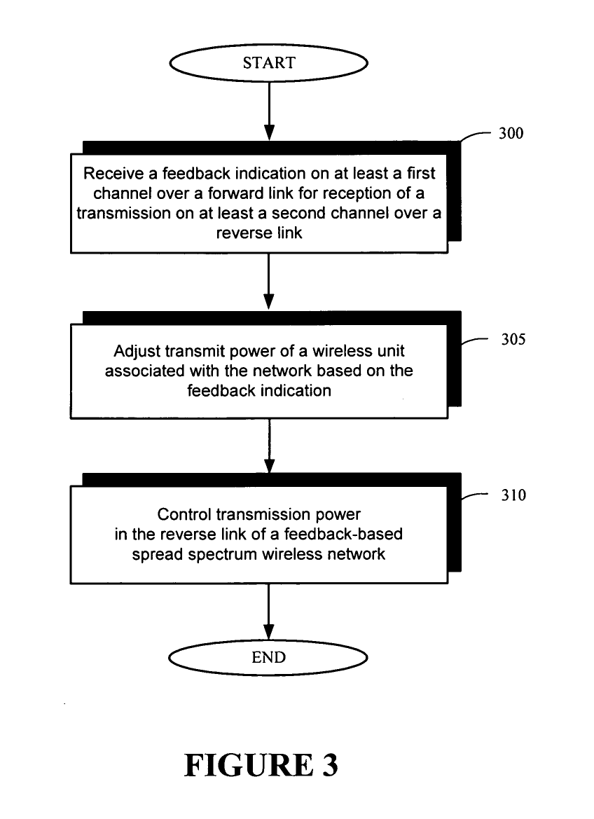

Turning now to FIG. 3, a stylized representation is illustrated for implementing a method of providing reverse link power control at the wireless unit 115 in the spread spectrum wireless communication system 100, as shown in FIG. 1, according to one embodiment of the present invention. At block 300, the transmitter 140 may receive, on the first channel 145(1) over the forward link 130, the feedback indication 15o for reception of the high-speed data 155 transmitted on the second channel 145(2) over the reverse link 125.

Based on the feedback indication 150, the transmitter 140 may adjust transmit power of the wireless unit 115, as shown in block 305. To adjust transmit power in the reverse link 125, the transmitter 140 may detect transmission activity on the first and second channels 145(1-2). In this way, the transmitter 140 controls transmission power in the reverse link 125 at the wireless unit 115 instead of using the receiver 165 at the first base station 105(1) for this purpose.

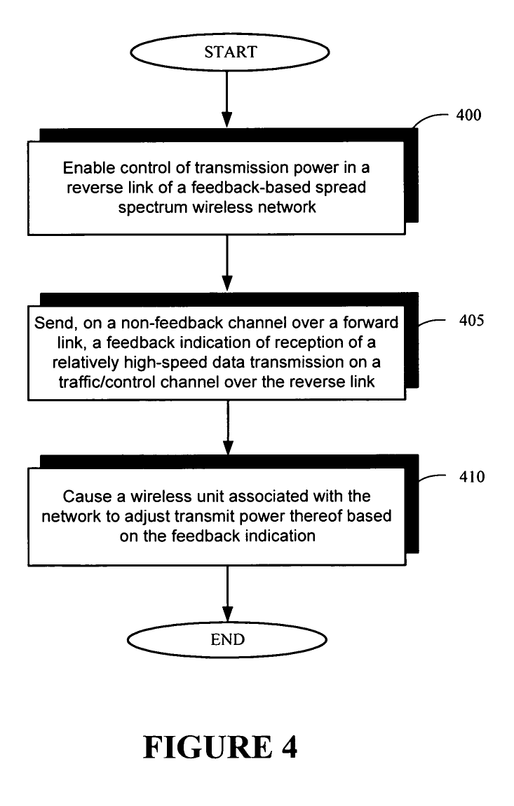

Referring to FIG. 4, a stylized representation of one exemplary embodiment of the instant invention is illustrated for implementing a method of using the transmitter 140 rather than the receiver 165 at the first base station 105(1) to control transmit power in the reverse link 125. At block 400, the transmitter 140 may be deposed at the wireless unit 115 to enable control of transmission power in the high-speed wireless data network 120 based on the feedback indication 150.

The first base station 105(1) may send, on a non-feedback channel, i.e., a feedback channel not provided for communicating power control commands, such as the first channel 145(1) over the forward link 130, the feedback indication 150 regarding receipt of the high-speed data 155 transmission on a traffic channel, i.e., the second channel 145(2) over the reverse link 125, as shown in block 405. Upon receiving the feedback indication 150, at block 410, the transmitter 140 may cause the wireless unit 115 associated with the network 120 to adjust transmit power thereof.

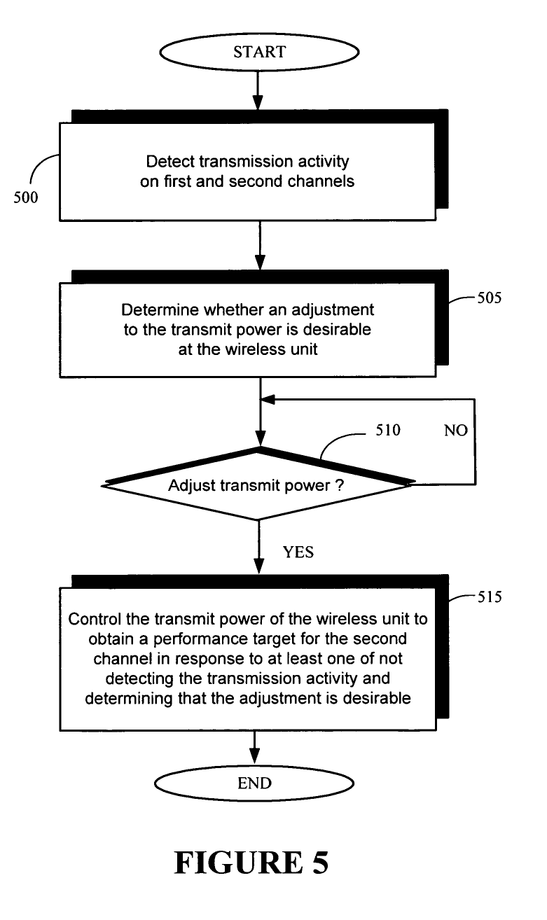

Finally, FIG. 5 illustrates a stylized representation of an exemplary embodiment of the instant invention for implementing a method of controlling transmit power in the reverse link 125 that neither uses a power control command channel or an inner-loop and/or an outer-loop based power control modules at the receiver 165. At block 500, to control transmit power in the reverse link 125, the transmitter 140 may detect transmission activity on the first and second channels 145(1-2) shown in FIG. 1. For example, the transmitter 140 may receive the feedback indication 150 on a channel that is available on the forward link 130 for another purpose than providing feedback, such as the ACK channel or the ARQ channel available on the forward link 130. Using the feedback indication 150, at block 505, the transmitter 140 may determine whether to adjust transmit power at the wireless unit 115.

A check 510 of the feedback indication 150 may indicate to the transmitter 140 that an adjustment may be desired. That is, in response to either not detecting any transmission activity and/or determining that some adjustment is desired, the transmitter 140 may control the transmit power of the wireless unit 115 to obtain the performance target 160 for the second channel 145(2). Accordingly, the transmitter 140 may cause the wireless unit 115 to increase the transmit power thereof, at block 515. Conversely, the transmitter 140 may cause the wireless unit 115 to decrease the transmit power thereof, at block 520. In this manner, by selectively controlling the transmit power of the wireless unit 115, in one illustrative embodiment, the transmitter 140 may provide a desired reverse link power control.

One or more feedback channels available for other purposes than power control command, for example, in EVDO Rev. A, multiple ARQ channels may be used on the forward link 130 to feedback receipt information of a reverse traffic channel. Therefore, the wireless unit 115 (the reverse link transmitter) becomes aware of the reverse traffic channel performance, and performs power control accordingly. When there is no traffic channel activity and it is still desirable to control the wireless unit 115 transmission power to achieve a target performance for the reverse control channel, such as the DRC channel, the wireless unit 11-5 may use a feedback channel, such as the DRCLock channel, to provide power control in the high-speed wireless data network 120.

In one embodiment, the high-speed wireless data network 120 may wirelessly communicate mobile data at a speed and coverage desired by individual users or enterprises. According to one embodiment, the high-speed wireless data network 120 may comprise one or more data networks, such as Internet Protocol (IP) network comprising the Internet and a public telephone system (PSTN). The 3rd generation (3G) mobile communication system, namely Universal Mobile Telecommunication System (UMTS) supports multimedia services according to 3rd Generation Partnership Project (3GPP) specifications. The UMTS also referred as Wideband Code Division Multiple Access (WCDMA) includes Core Networks (CN) that are packet switched networks, e.g., IP-based networks. Because of the merging of Internet and mobile applications, the UMTS users can access both telecommunications and Internet resources. To provide an end-to-end service to users, a UMTS network may deploy a UMTS bearer service layered architecture specified by Third Generation Project Partnership (3GPP) standard. The provision of the end-to-end service is conveyed over several networks and realized by the interaction of the protocol layers.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention set forth above is described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

While the invention has been illustrated herein as being useful in a telecommunications network environment, it also has application in other connected environments. For example, two or more of the devices described above may be coupled together via device-to-device connections, such as by hard cabling, radio frequency signals (e.g., 802.11(a), 802.11(b), 802.11(g), Bluetooth, or the like), infrared coupling, telephone lines and modems, or the like. The present invention may have application in any environment where two or more users are interconnected and capable of communicating with one another.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices as well as executable instructions contained within one or more storage devices. The storage devices may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions, when executed by a respective control unit, causes the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

We claim:

1. A method for communication with at least one wireless unit over a forward and a reverse link in a wireless network, the method comprising:
receiving a feedback indication on at least a first channel over said forward link for reception of a transmission on at least a second channel over said reverse link; and
adjusting transmit power of the wireless unit associated with said network based on said feedback indication.

2. A method, as set forth in claim 1, wherein receiving a feedback indication further comprises:
controlling transmission power in said reverse link of a spread spectrum wireless communication system based on said received feedback indication.

3. A method, as set forth in claim1, further comprising:
receiving, at the wireless unit, said feedback indication for reception of a traffic channel on a channel that is available on said forward link for another purpose than providing power control feedback.

4. A method, as set forth in claim 2, wherein receiving a feedback indication further comprises:
using an acknowledgement channel available on said forward link between a base station and the wireless unit to receive an indication for reverse traffic channel performance from a receiver associated with said base station.

5. A method, as set forth in claim1, further comprising:
detecting transmission activity on said first and second channels; and
determining whether an adjustment to the transmit power is desirable at the wireless unit.

6. A method, as set forth in claim 1, further comprising:
controlling the transmit power of the wireless unit to obtain a performance target for said second channel in response to at least one of not detecting said transmission activity and determining that said adjustment is desirable.

7. A method, as set forth in claim 1, further comprising:
performing power control in said reverse link at a transmitter associated with the wireless unit.

8. A method, as set forth in claim 7, further comprising:
controlling the transmit power of the wireless unit to cause said transmitter to reach a performance target for a reverse traffic channel.

9. A method, as set forth in claim 7, further comprising:
controlling the transmit power of the wireless unit to cause said transmitter to reach a performance target for a reverse control channel.

10. A method, as set forth in claim 7, further comprising:
adjusting the transmit power of said transmitter based on at least one of a local traffic indication and a traffic quality of service criteria.

11. A method, as set forth in claim 7, further comprising:
causing said transmitter to execute an application in the wireless unit at a desired performance level.

12. A method, as set forth in claim 7, further comprising:
causing said transmitter associated with the wireless unit to increase capacity of an access network by a desired level.

13. A method, as set forth in claim 12, further comprising:
reducing at least one of latency and processing associated with performing the power control in said reverse link for said relatively high-speed data transmission; and
enhancing a performance metric of said access network in response to reducing at least one of latency and processing.

14. A method, as set forth in claim 7, further comprising:
eliminating an overhead associated with a power control command channel; and
enhancing an efficiency metric of an air interface of said forward link in response to eliminating said overhead.

15. A method for communication with a wireless unit and a network, the method comprising:
sending, on a non-feedback channel over a forward link, a feedback indication for reception of a transmission on a traffic channel over said reverse link; and
causing a wireless unit associated with said network to adjust transmit power thereof to enable control of transmission power in said reverse link based on said feedback indication.

16. A method, as set forth in claim 15, wherein sending, on a non-feedback channel over a forward link, a feedback indication for reception further comprises:
using an acknowledgement channel available on said forward link for another purpose than providing power control feedback to send said feedback indication to the wireless unit, wherein said network is a spread spectrum wireless network.

17. A method, as set forth in claim 16, further comprising:
sending an indication for performance of said traffic channel from a base station controller having a receiver to control the transmit power of a transmitter associated with the wireless unit.

18. A method for wireless communication with a wireless unit and a network, the method comprising:
sending, on a non-feedback channel over a forward link, a feedback indication for reception of a transmission on a control channel over said reverse link; and
causing a wireless unit associated with said network to adjust transmit power thereof based on said feedback indication to enable control of transmission power in said reverse link.

19. A method, as set forth in claim 18, wherein sending, on a non-feedback channel over a forward link, a feedback indication for reception further comprises:
using an acknowledgement channel available on said forward link for another purpose than providing power control feedback to send said feedback indication to said wireless unit, wherein said network is a spread spectrum wireless network.

20. A method, as set forth in claim 19, further comprising:
sending an indication for performance of said control channel from a base station controller having a receiver to control the transmit power of a transmitter associated with the wireless unit.
